(19) United States
(12) Patent Application Publication
(10) Pub. No.: US 2006/0136644 A1
(43) Pub. Date: Jun. 22, 2006

(54) SAS hot swap backplane expander module

(76) Inventors: Cynthia L. Martin, Olympia, WA (US); Craig J. Jahne, Beaverton, OR (US); Donald L. Faw, Hillsboro, OR (US)

Correspondence Address: CARRIE A. BOONE, P.C., 2450 LOUISIANA, SUITE 400-310, HOUSTON, TX, 77006, US

(21) Appl. No.: 11/017,611

(22) Filed: Dec. 20, 2004

(51) Int. Cl. G06F 13/00

(52) U.S. Cl. 710/302

(57) ABSTRACT

An expander module for connection to a hot-swap backplane is disclosed.

### FIELD OF THE INVENTION

This invention relates to serial attached SCSI (SAS) technology and, more particularly, to an expander module to be used in SAS environments.

### BACKGROUND OF THE INVENTION

For some time, small computer systems interface (SCSI) disk drives have been used in processor-based systems to provide non-volatile storage of application software, operating systems, and data. Where multiple drives were present, SCSI drives generally operated in parallel.

A recent standard for supporting drive technology, known as serial attached SCSI, or SAS, employs a serial interface for connecting multiple disk drives to the processor-based system. SAS uses small form factor (SFF) connectors and thinner cabling than the parallel SCSI paradigm. SAS will work with either SAS (SCSI) disk drives or serial advanced technology attachment (SATA) drives, also known as integrated drive electronics (IDE) disk drives. SAS supports legacy software, such as currently available SCSI programs.

The SAS standard purports to satisfy the needs of all consumer types, whether they are purchasing a personal computer, an enterprise system, a server, a network, and so on. In other words, the SAS standard is said to be scalable to many different environments. SAS uses very large scale integration (VLSI) to enable a highly scalable connection scheme between drives. SAS also employs the use of “expanders” to provide fan-out for large drive configurations.

A disk drive controller, or SAS controller, may be an integrated circuit (IC) disposed on a printed circuit board (PCB), such as a motherboard or add-in card. A hot-swap backplane (HSBP) may be used to simultaneously connect multiple disk drives to the SAS controller. The HSBP is coupled to the SAS controller with cabling. Attached to some HSBPs are two small form factor connectors, known as SFF 8484 connectors, for cabling to the SAS controller. The SAS controller may have four ports or eight ports. When one connector is coupled between the HSBP and the eight-port SAS controller, four of the ports are accessible; when two connectors are connected, all eight ports of the controller may be used.

An expander may also be part of the SAS environment. By increasing the number of ports supported by the controller, expanders allow the connection topology to grow, such as for enterprise configurations featuring many disk drives. The expander may be in the form of an IC, known as an expander chip; the ports added by the expander allow the SAS controller to support more drives.

### BRIEF DESCRIPTION OF THE DRAWINGS

FIG. 1 is a block diagram of a SAS disk drive environment, including two SAS expander modules, according to some embodiments;

FIG. 2 is a perspective view diagram of an expander board, according to some embodiments;

FIG. 3 is a perspective view diagram of the expander board of FIG. 2 connected to a hot-swap backplane, according to some embodiments;

FIGS. 4A and 4B are top and side views, respectively, of the mating connector used to connect the expander board to the hot-swap backplane in FIG. 3, according to some embodiments; and

FIG. 5 is a block diagram of a processor-based system using the expander board and hot-swap backplane of FIG. 3, according to some embodiments.

### DETAILED DESCRIPTION

In accordance with the embodiments described herein, an expander module for connection to a hot-swap backplane is disclosed. The expander module includes an expander IC which supplies expanded port functionality to a disk drive controller. The expander module also includes a pair of mating connectors, typically found on cabling, for mechanically and electrically coupling the expander module to connectors on the hot-swap backplane. In some embodiments, the connectors and mating connectors are compatible with multi-lane internal serial attachment connectors, hereinafter described as SFF 8484 connectors. The expander module thus enables a building-block approach to drive expansion, as the backplane does not automatically include the enhanced port functionality. The modular approach keeps the cost of the hot-swap backplane low and efficiently allocates costs to those customers who desire the additional functionality.

In the following detailed description, reference is made to the accompanying drawings, which show by way of illustration specific embodiments in which the invention may be practiced. However, it is to be understood that other embodiments will become apparent to those of ordinary skill in the art upon reading this disclosure. The following detailed description is, therefore, not to be construed in a limiting sense, as the scope of the present invention is defined by the claims.

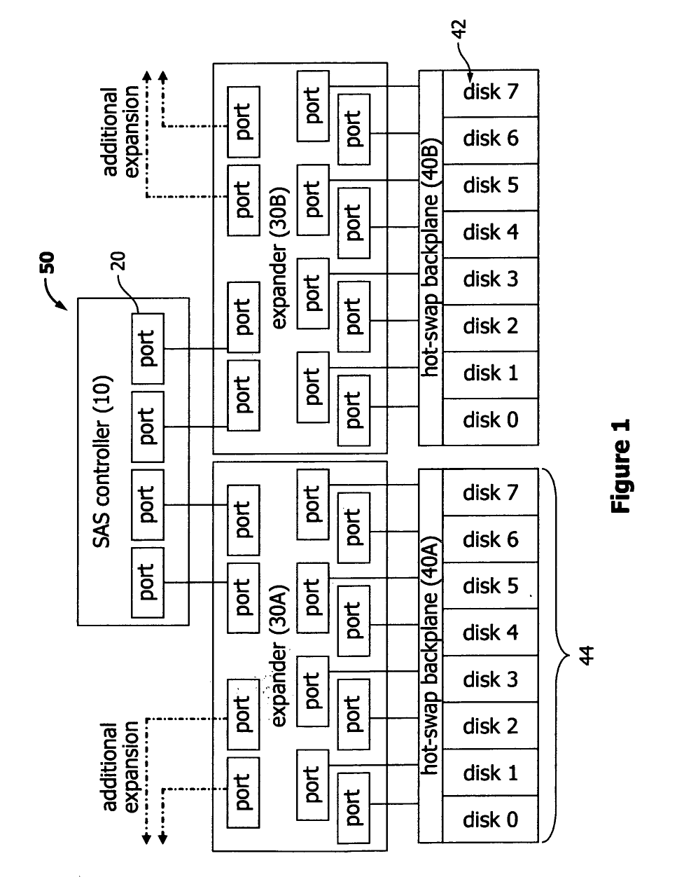

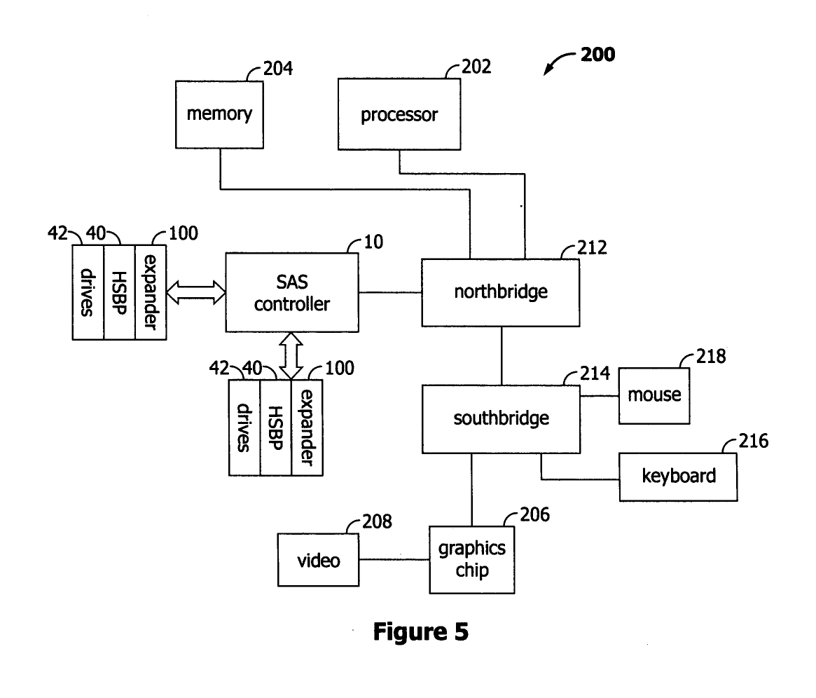

In FIG. 1, according to some embodiments, a schematic view of a SAS disk drive configuration 50 is depicted, including two expander modules 30A and 30B (collectively, expander modules 30). The SAS disk drive configuration 50 is part of a processor-based system, such as a personal computer, an enterprise system, or a server. (One example of a processor-based system 200 is depicted in FIG. 5, below.) The SAS controller 10 of FIG. 1 includes four ports 20. (SAS controllers with eight and twelve ports are also available.) Without support of the expander modules, the SAS controller 10, with four output ports, can support four disk drives. The two expander modules 30 enable the SAS controller 10 to support sixteen drives.

Like controllers, expander modules can support various numbers of ports. While the expander modules 30 of FIG. 1 each include twelve ports 20, expander modules with four ports, eight ports, and other configurations are possible. The expander ports can be configured to be input ports or output ports, as long as one of the ports is an input port. Two ports 20 of the expander module 30A are connected to two ports 20 of the SAS controller 10. (While a single-port connection may be made between the controller and the expander, a two-port connection is optimal, in some embodiments.) Two ports 20 of the expander module 30B are connected to the remaining two ports 20 of the SAS controller 10.

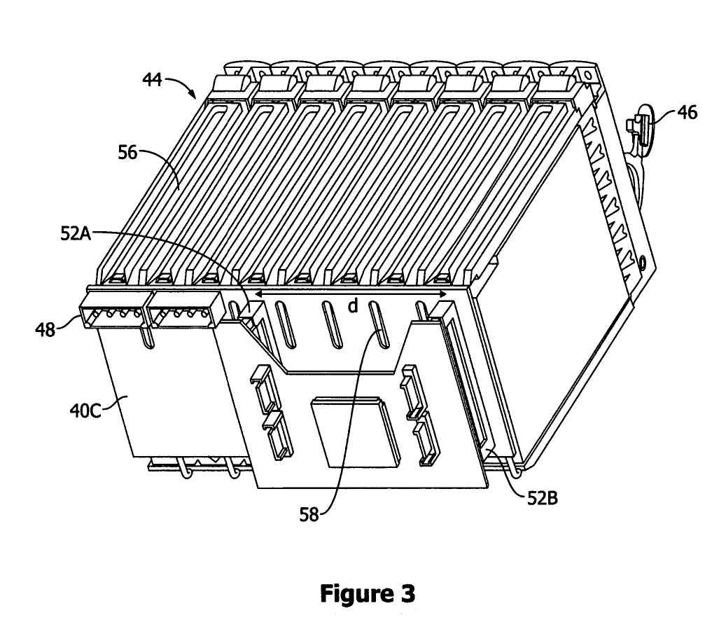

Eight ports 20 of the expander module 30A connect to eight disks 42 by way of a hot-swap backplane 40A; likewise, eight ports 20 of the expander module 30B connect to eight disks 42 by way of a hot-swap backplane 40B (collectively, hot-swap backplanes 40). The drives 42 may be enclosed in a drive bay 44, such as the one depicted in FIG. 3, below. Alternatively, each port of the expanders 30A and 30B may be separately connected to a free-standing disk drive. The expanders 30A and 30B include two additional ports, which may be used to connect to other drives, other controllers, or other expanders. The SAS disk drive configuration 50 shows that, using two expanders, a SAS controller with four ports can support sixteen drives.

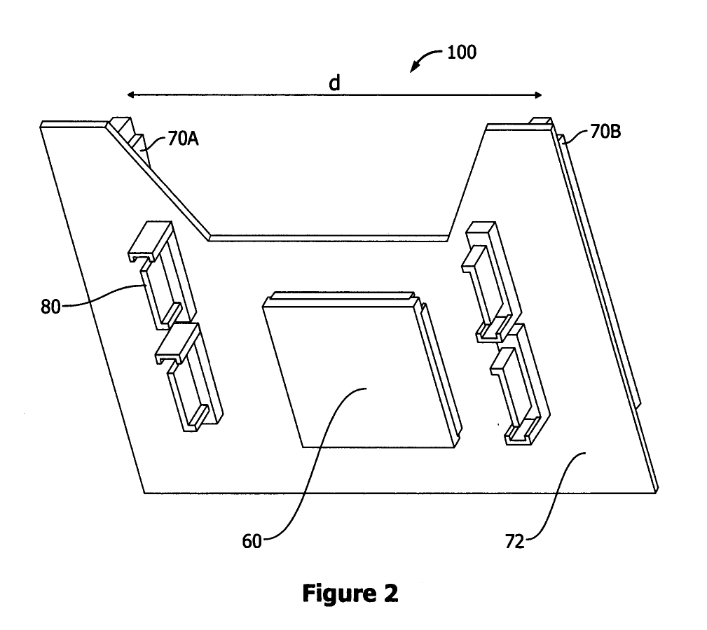

In FIG. 2, a perspective view of an expander module 100 is featured, according to some embodiments. The expander module 100 may be part of the SAS disk drive configuration 50 of FIG. 1. The expander module 100 includes an expander IC 60 and may be coupled to an HSBP, such as the HSBP 40C of FIG. 3, below.

The expander module 100 is a printed circuit board 72 for holding the expander IC 60 and for connection to the HSBP 40C. The backside of the PCB 72 also includes two mating connectors 70A and 70B (collectively, mating connectors 70). In some embodiments, the mating connectors 70 are SFF 8484-compatible. The mating connectors 70 are typically part of a cable assembly. In the expander module 100, the mating connectors 70 are attached to the PCB 72, such as by soldering or press-fitting thereon. As shown in FIG. 2, the mating connectors 70A and 70B are spaced a distance d apart so as to mate with the connectors of a HSBP, such as connectors 52A and 52B of HSBP 50C, shown in FIG. 3. Mating connector 70A couples with the connector 52A; mating connector 70B couples with the connector 52B.

A rear perspective view of a SAS hot-swap backplane 40C coupled to a drive bay 44, is depicted in FIG. 3, according to some embodiments. The HSBP 40C and drive bay 44 are part of a processor-based system, such as the system 200 of FIG. 5. The drive bay 44 includes eight drive carriers 56, inside which individual disk drives (not shown) may be inserted. A drive ejection lever 46 enables the drives to be removed. In the SAS environment, the disk drives may be hot-swapped, that is, inserted and removed from the drive bay 44 without removing power to the processor-based system.

The disk drives interface with the controller by way of the HSBP 40C. The HSBP 40C provides a mechanical attach point to support hot-swapping each disk drive. The HSBP 40C also provides power distribution to the disk drives and light-emitting diode (LED) support for each disk drive. The LEDs indicate drive activity and also indicate if there is a fault with the disk drive.

The HSBP 40C is a printed circuit board (PCB). The HSBP 40C includes circuitry (not shown) to electrically and mechanically connect to the disk drives upon insertion. The HSBP 40C includes two connectors 48, for connecting to a power supply (not shown). From the connectors 48, a voltage is supplied to the drives populating each drive carrier 56 of the drive bay 44.

The HSBP 40C also includes two connectors 52A and 52B (collectively, connectors 52) disposed behind the expander module 100 in FIG. 3. The connectors 52, which are a distance d apart, are used to electrically couple the disk drives to the SAS controller 10, whether by way of the expander module 100, or by direct connection. In some HSBPs, the host connectors are SFF 8484-compatible connectors. Each connector 52 usually mates with a cable assembly. The cable assembly (not shown) inserted into the connector 52A, may connect between the HSBP 40C and a SAS controller, such as is depicted schematically in FIG. 1, enabling access to all four of the controller ports 20. Where connection to an eight-port controller is made, both connectors 52A and 52B are used, so as to obtain the full complement of ports available from the controller.

In SAS, each disk drive is connected by a point-to-point connection and is not daisy-chained. Environments in which multiple disk drives are supported, such as enterprise servers, may use eight, sixteen, or more disk drives. With point-to-point connections, eight to sixteen cables would adversely affect the reliability and serviceability (RAS), manufacturability, and field servicing of the system, as each connection point is a potential point of failure. An expander allows a minimum number of cables to attach to multiple disk drives.

The HSBP itself may include expander functionality. For example, an expander IC, such as the expander IC 60 disposed on the expander module 100, may instead be coupled directly to the printed circuit board of a hypothetical HSBP (not shown). The expander IC 60 is a switching matrix, for selecting which drive has access to the controller. By placing the expander IC 60 directly on the hypothetical HSBP, twelve additional ports (besides the ones in the controller) are available to the drives, without using the expander module 100, as in FIG. 3. The SAS configuration 50 of FIG. 1 is thus possible.

However, adding port functionality is not cheap. A SAS controller that supports twelve ports may be expected to be more expensive than the eight-port controller, which is more expensive than the four-port controller. Likewise, the expander IC 60 has an associated cost. Thus, adding the expander IC 60 directly to the hypothetical HSBP adds to the overall cost to the device, making the hypothetical HSBP more expensive than the HSBP 40C of FIG. 3, which does not include expander functionality.

Not every customer will need the added functionality provided in the expander IC 60. With the expander IC 60 embedded in the hypothetical HSBP design, customers who do not need port expansion would nevertheless pay for the functionality. As another possibility, both the HSBP 40C (for the limited functionality customers) and the hypothetical HSBP (for the higher-end customers) may be produced, adding complexity to the manufacture and sale of HSBPs. Another possibility is to keep the expander functionality separate from, yet connectable to, the HSBP, as in FIG. 3.

Returning to FIG. 2, the expander module 100 includes four connectors 80. The connectors 80 are used as inputs to couple the expander board to the SAS controller 10. Alternatively, one or more of the connectors 80 may be used to connect to an additional expander board. Four connectors, one for each port, are available, for maximum flexibility in configuration options. In FIG. 2, the connectors 80 are smaller than the connectors 52. As another option, the connectors 80 may be SFF 8484-compatible connectors, enabling many connection possibilities with a single type of cable assembly.

The expander module 100 in FIG. 2 adds twelve ports to those provided by the disk drive controller. Thus, the expansion module 100 enables one input port and eleven output ports, two input ports and ten output ports, three input ports and nine output ports, or four input ports and eight output ports. However, a variety of combinations of input and output ports can be supported, simply by adding or changing the number of expansion connectors 80. The expander module 100 promotes modularity in configuring drives under the SAS paradigm.

The expander module 100 may be connected to a fanout expander device, to increase the number of disk drives supported by the controller. A fanout expander device is an expander device that is capable of being attached to two or more edge expander device sets, where an edge expander device is an expander device that is part of a single edge expander device set. The expander IC 60 has twelve ports, although other expanders may support a different number of ports. The expander IC 60 can support up to 128 SAS addresses. If a fanout expander is attached (using one of the connectors 80), a total of 16,384 devices could theoretically be supported. The expander IC 60 can be configured so that one port is the input from the SAS controller and the other eleven ports are used to connect directly to the disk drives. (However, in some embodiments, improvements in performance are found when two ports are used as inputs to the SAS controller.) The expander IC 60 thus both increases the number of devices supported and reduces the number of cables used.

The PCB 72 of the expander module 100 is rectangular, with a portion removed from the top. The HSBP 40 includes vents 58, for improving the air flow in the drive bays 44. As another possibility, the PCB 72 may be rectangular without the cutout portion and include its own vents, for improved air circulation. The PCB 72 may be designed according to a number of shapes and sizes, as long as the distance d between the mating connectors 70 is maintained. The shape of the expander module 100 may be decided according to the air flow requirements of the system. The PCB 72 may include additional support circuitry, such as a voltage regulator, an oscillator, and capacitors (not shown).

In FIG. 3, the expander module 100 is coupled to the HSBP 40. Upon insertion to the HSBP 40C, the expander module 100 provides an electrical and mechanical connection between the two devices. Connection from the HSBP/expander module to the SAS controller 10 is made using one or more cable assemblies coupled to the expansion connectors 80. In this manner, additional functionality is added to, or “piggy-backed,” onto the HSBP 40. The HSBP may support 2.5″ or 3.5″ hard disk drives.

The coupling of the connectors 52 with the mating connectors 70 forms both a mechanical and an electrical attachment between the HSBP 40 and the expander chip 60. By having the expander IC 60 on the expander module 100, the extra cost of the chip is moved away from the HSBP 40.

In addition to reducing the number of cables used, the expander module 100 is a building block, allowing for a low-cost SAS entry solution that can be easily upgraded in the field or on the assembly line. The expander module 100 will be moderately expensive, given the additional port functionality it provides. By leaving the expander function off the HSBP, the cost of the backplane is minimized.

Further, since the expander module 100 can mate to the HSBP, it is not necessary to manufacture two different HSBPs, one with expander capability (e.g., the hypothetical HSBP, described above) and one without expander capability (e.g., the HSBP 40C of FIG. 3). Instead, the expander module 100 can be sold to those customers who desire and are willing to pay for the additional SAS functionality, while a single HSBP is available at a relatively low cost. For system integrators and value-added resellers (VARs), the expander module 100 thus simplifies inventory management and system integration.

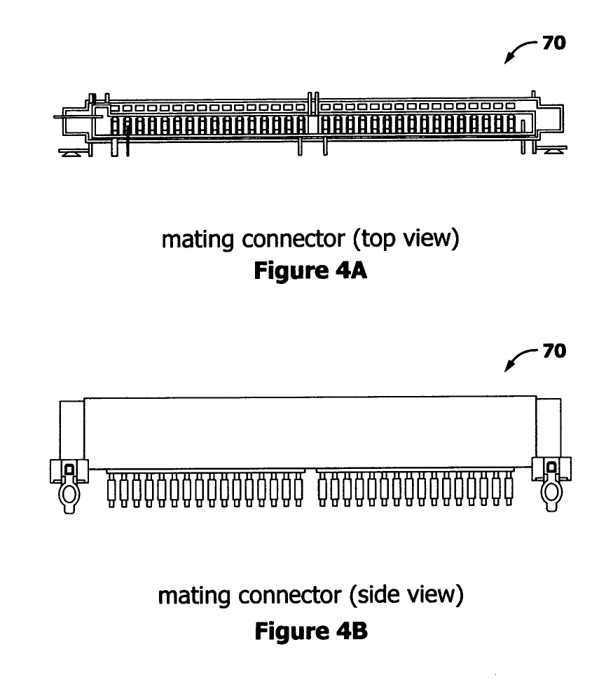

In FIGS. 4A and 4B, top and side views, respectively, of the mating connector 70 are depicted, according to some embodiments. The mating connectors 70 are disposed on the PCB 72 of the expander module 100 for connection to the connectors 52 of the HSBP. In some embodiments, the mating connectors 70 are SFF 8484-compatible. The mating connectors 70 are substantially similar to the end portions of the cables used to connect with the connectors 52. Because the connectors 52 and the mating connectors 70 provide electrical connection between the HSBP 40 and the expander module 100, the connectors 70 include contacts, which are typically gold-plated, but may also be copper alloy or some other conductive material, for mating with associated contacts within the connectors 52. The mating connectors 70 and the connectors 52 further provide mechanical attachment between the HSBP 40 and the expander module 100. Accordingly, the housing of the mating connectors 70 is substantially rigid. In some embodiments, the housing is made using a rigid plastic material that does not deform at high temperatures.

The modularity embodied by the expander module 100 may be extended to non-SAS environments. For example, under serial ATA, additional port functionality is obtained using a port multiplier. The port multiplier can be configured to connect between a hot-swap backplane housing multiple drives and the controller in a manner similar to the configuration of the expander module 100 and the HSBP 40C, described above.

In FIG. 5, a processor-based system 200 is depicted, according to some embodiments. A processor 202, a memory 204, and a SAS controller 10 are connected to a northbridge 212. The SAS controller includes two expander modules 100 and two HSBPs 40, each of which are coupled to drives 42, similar to the configuration of FIG. 1. The northbridge 212 is coupled to a southbridge 214, which includes functionality for a keyboard 216 and a mouse 218. A graphics chip 206 is also connected to the southbridge 214. A video display 208 is operated by the graphics chip 206. The configuration 200 depicted in FIG. 5 is merely representative of configurations that may support SAS disk drive configurations with the expander module 100.

While the invention has been described with respect to a limited number of embodiments, those skilled in the art will appreciate numerous modifications and variations therefrom. It is intended that the appended claims cover all such modifications and variations as fall within the true spirit and scope of the invention.

We claim:

1. An expander module, comprising:
an expander integrated circuit, for adding port functionality to a disk drive configuration, wherein the expander integrated circuit is disposed on a printed circuit board; and
a pair of mating connectors, for coupling to a corresponding pair of connectors on a hot-swap backplane, wherein an electrical connection between drives coupled to the hot-swap backplane and the expander integrated circuit is established when the pair of mating connectors is coupled to the pair of corresponding connectors;
wherein a mechanical connection between the expander module and the hot-swap backplane is established when the electrical connection is made.

2. The expander module of claim 1, further comprising:
a number of expansion connectors, wherein one of the expansion connectors couple the expansion module to a disk drive controller.

3. The expander module of claim 2, wherein the number is four.

4. The expander module of claim 2, wherein the disk drive controller is a serial attached small computer systems interface controller.

5. The expander module of claim 1, wherein the pair of mating connectors and the pair of connectors are small form factor 8484-compatible.

6. The expander module of claim 2, wherein the expansion connectors are small form factor 8484-compatible.

7. A disk drive configuration, comprising:
a controller, the controller including first ports;
a backplane coupled to a plurality of disk drives, the backplane comprising a pair of connectors, the pair of connectors being a predetermined distance apart, wherein the plurality of disk drives are electrically connected to the pair of connectors when coupled to the backplane; and
an expander module, the expander module comprising:
second ports, wherein the expander module is connected to the controller by coupling one of the first ports to one of the second ports; and
a pair of connector mates, the pair of connector mates being the predetermined distance apart; and
wherein the pair of connectors and the pair of connector mates establish an electrical connection between the controller and the plurality of disk drives.

8. The disk drive configuration of claim 7, wherein the pair of connectors and the pair of connector mates are small form factor 8484-compatible.

9. The disk drive configuration of claim 8, further comprising:
a second backplane, comprising bays for a second plurality of drives; and
a second expander module comprising third ports, wherein the second expander module is connected to the controller by coupling a second port of the first ports to one of the third ports.

10. The disk drive configuration of claim 7, wherein the first ports comprise four ports and the second ports comprise twelve ports.

11. The disk drive configuration of claim 9, wherein the first ports comprise eight ports, the second ports comprise twelve ports, and the third ports comprise twelve ports.

12. The disk drive configuration of claim 11, wherein the controller is electrically connected to sixteen drives.

13. The disk drive configuration of claim 7, the expander module further comprising expansion connectors, wherein a cable coupled between a first connector of the expansion connectors and the controller provides an electrical connection between the expander module and the controller.

14. The disk drive configuration of claim 8, further comprising a second cable coupled between a second connector of the expansion connectors and a second expansion module.

15. The disk drive configuration of claim 8, further comprising a third cable coupled between a third connector of the expansion connectors and a second controller.

16. A processor-based system, comprising:
a processor and a memory coupled to a bridge;
a controller coupled to the bridge, the controller including controller ports;
a backplane for coupling the controller to a plurality of disk drives, the backplane comprising a pair of connectors, the pair of connectors being a predetermined distance apart, wherein the plurality of disk drives are electrically connected to the pair of connectors when installed in the processor-based system; and
an expander module, the expander module comprising:
expander ports, wherein the expander module is connected to the controller by coupling a first port of the controller ports to a first port of the expander ports; and
a pair of connector mates, the pair of connector mates being the predetermined distance apart, wherein the pair of connectors and the pair of connector mates establish an electrical connection between the controller and the plurality of disk drives.

17. The processor-based system of claim 16, further comprising:
a second backplane for coupling a second plurality of disk drives to the controller, the second backplane comprising a second pair of connectors, wherein the second plurality of disk drives are electrically connected to the second pair of connectors when installed in the processor-based system; and
a second expander module, the second expander module comprising:
second expander ports, wherein the second expander module is connected to the controller by coupling a second port of the controller ports to a first port of the second expander ports; and
a second pair of connector mates, wherein the second pair of connectors and the second pair of connector mates establish an electrical connection between the controller and the second plurality of disk drives;
wherein the processor executes instructions on behalf of the first plurality of disk drives and on behalf of the second plurality of disk drives.

18. A system, comprising:
a controller comprising ports;
a hot-swap backplane comprising a connector for coupling to the controller by disposing a cable between the connector and the controller; and
an expander, the expander comprising expander ports;
wherein the expander ports are not part of the hot-swap backplane.

19. The system of claim 18, further comprising:
a disk drive bay for housing one or more disk drives, the disk drive bay being electrically and mechanically connected to the hot-swap backplane, wherein the one or more disk drives connect to the controller through the expander ports.

20. The system of claim 19, the expander further comprising:
a second connector, the second connector for coupling the expander to a second expander.
